(19) United States
(12) Patent Application Publication
(10) Pub. No.: US 2008/0317569 A1
(43) Pub. Date: Dec. 25, 2008

(54) Partial Lifting Loading Platform

(76) Inventor: Gerd Baer, Heilbronn (DE)

Correspondence Address: DREISS, FUHLENDORF, STEIMLE & BECKER, POSTFACH 10 37 62, D-70032 STUTTGART, DE

(21) Appl. No.: 11/659,200

(22) PCT Filed: Aug. 10, 2005
(86) PCT No.: PCT/EP05/08665

§ 371 Date: Feb. 2, 2007

(30) Foreign Application Priority Data
Aug. 31, 2004 (EP) 04020585.8

(51) Int. Cl. B60P 9/00

(52) U.S. Cl. 414/462

(57) ABSTRACT

A lifting loading platform (1) to be fastened to motor vehicles comprises a platform (20) and a substantially parallelogram lifting gear (10) having two horizontally spaced-apart supporting arms (12, 14) for carrying the platform (20), at least one parallel cylinder (13) for pivoting the platform (20) about a pivot axis (19) from its vertical position of travel into its horizontal position of operation and vice versa, and at least one lifting cylinder (15) for lifting and lowering the platform (20) in its position of operation. The platform (20) is spaced apart from the one, second supporting arm (14) in a transverse direction and is mounted on the second supporting arm (14) so as to be pivoted about the pivot axis (19) by means of a transversal bar (23) bridging the transverse distance (D).

The present invention concerns a lifting loading platform to be fastened to motor vehicles, comprising a platform and a substantially parallelogram-shaped lifting gear comprising two horizontally spaced-apart support arms for supporting the platform, at least one parallel cylinder for pivoting the platform about a pivot axis from its vertical position of travel into its horizontal operating position and vice versa, and at least one lifting cylinder for lifting and lowering the platform in its operating position.

Lifting loading platforms of the so-called standard version have a one-piece platform which is disposed behind the construction or seals it. A subcategory of these standard lifting loading platforms includes those which extend only over part of the vehicle width. For this reason, they are also called partial lifting loading platforms. Such partial lifting loading platforms are used for medium-size and small distributor vehicles which require unloading of larger, rollable loads using the lifting loading platform, and also direct removal of smaller consignments such as portable packages.

When the door has two wings, the lifting loading platform must have an appropriate platform width, such that at least one door may be opened without having to open the lifting loading platform. One reason therefore is to save time and also the fact that such vehicles are generally vehicles that transport refrigerated or deep-frozen goods, the opening cross-section of which must be minimized in order to prevent cold from escaping. Such lifting loading platforms are manufactured as a one-third version (vehicle has a door consisting of three parts), a semi-version (vehicle has two doors of identical size) and a two-third version (vehicle has doors consisting of three parts).

For all versions, the lifting gear depends on the width of the platform. The lifting gear is mounted to the chassis or mounting frame construction in a conventional fashion. For this reason, the one-third version requires one left and one right-hand lifting gear and the semi and two-third versions also require one right and one left-hand lifting gear. Although the lifting gear of all embodiments is mounted to both sides of the vehicle frame, the forces are introduced substantially to that side of the frame having the platform. This is no problem for medium-size vehicles, but creates problems for very light utility vehicles. In this case, the overall frame construction and also the mounting elements between the vehicle frame and the lifting gear must be designed to withstand the double (since unilateral) load. Also the basic overall lifting gear structure itself must be designed to withstand the unilateral load. The vehicle conditions e.g. of very light utility vehicles (2.8 t to 3.5 t) therefore limit the hauling capacity of the lifting loading platform.

Conventional partial lifting loading platforms of the semi and two-third version always have a supporting or lifting arm element between the two longitudinal supports of the vehicle. This requires space both for a bar coupling and a spherical coupling. In most cases, the final traverse of the vehicle frame blocks the path and must be removed or shifted to the front. When the final traverse is removed, a complex substitute construction is required.

In contrast thereto, it is the underlying purpose of the present invention to eliminate these disadvantages of a lifting loading platform of the above-mentioned type.

This object is achieved in accordance with the invention in that the platform or a solid part of the platform is separated from the second support arm in a transverse direction and is disposed on the second support arm via a transverse support bridging this transverse separation, such that it can be rotated about the pivot axis.

The inventive design is based on a two-cylinder series lifting gear, with the first support arm being disposed on the left-hand side and the second support arm (lifting arm) on the right-hand side (viewed in the direction of travel). The normal lifting loading platform has a platform which is connected to the lifting gear through a left and a right-hand connecting head. The invention proposes production of a partial lifting loading platform from this “entire” lifting loading platform by simply cutting the platform to the shape required by the customer, either as a semi or two-thirds version.

In the present case, one obtains a partial lifting loading platform with a platform on the left-hand side, as viewed in the direction of travel, which is called left-hand design below. “Cutting” only leaves the connecting head on the support arm side which also contains the parallel cylinder. Thus, the platform would be completely instable in a transverse direction relative to the travelling direction. In order to provide stability, the platform is provided with the connecting or transverse support which is disposed in the center of motion of the support arms. This transverse support is simply screwed to the platform. This connecting support terminates in a bolt on the opposite side, which is disposed in the second support arm (lifting arm). This provides the platform with a defined guidance and stability in the transverse direction as well. In order to also provide the platform with this transverse stability when it is supported on the ground, a second bottom roller must be mounted to the platform. The platform then has the required transverse stability when it is supported on the ground. The above-mentioned connecting support and the bearing in the lifting arm must be designed such that these components come to rest approximately 10 mm below the loading edge for all possible assemblies. This is required to pivot the door, that can be opened, over these components and into an open position when the platform is closed. When a partial lifting loading platform of the right-hand design is required, the lifting gear must also be designed as a right-hand gear, i.e. the support arm side must be disposed on the right-hand side and the lifting arm side on the left-hand side. The mounting to the vehicle frame remains. For this reason, the space between the two longitudinal supports of the vehicle is also free and a bar coupling or spherical coupling can be mounted as in a conventional lifting loading platform.

If required, the inventive design also permits platforms which are wider than would be possible due to the required door width. This is realized by mounting a folding part at this location, whose longitudinal section corresponds to the platform. In accordance with the invention, the folding part that projects through abutment is additionally supported on the transverse support. This provides the folding part with a very high stability, permitting folding parts of extremely large widths.

For smaller utility vehicles, such as box-type delivery vans, the width of the platform is limited by the prescribed visibility of the rear lights and also by the central door division. This narrow platform is too narrow for transporting pallets. With the proposed technology, the folding part may be selected to have the same width as the platform itself. The user then has a full-value lifting loading platform with a “whole” platform.

The inventive embodiment permits first-time use of a pallet-compatible loading aid with a loading capacity of more than 500 kg even for small utility vehicles, such as box-type delivery vans, which also permits free access to the cargo space via the right wing door.

The platform may have a larger width in the operating position than in prior art. This allows transport of Euro pallets including lifting trucks using small vehicles, and a wide platform in large vehicles facilitates manoeuvring during unloading the vehicle and offers the operating personnel more stability due to the larger platform.

The inventive embodiment does not limit the use of drawbar couplings and greatly reduces the number of components. The series lifting gear of the producer is also a lifting gear for the partial lifting loading platform (right or left-hand). Only one lifting gear of the opposite version is required. Symmetrical introduction of forces into the vehicle permits construction which is favorable in view of weight.

Further preferred embodiments of the invention are subject matter of the dependent claims. Further advantages of the invention can be extracted from the description and the drawing. The features mentioned above and below may be used individually or collectively in arbitrary combination. The embodiments shown and described are not to be understood as exhaustive enumeration but have exemplary character for describing the invention.

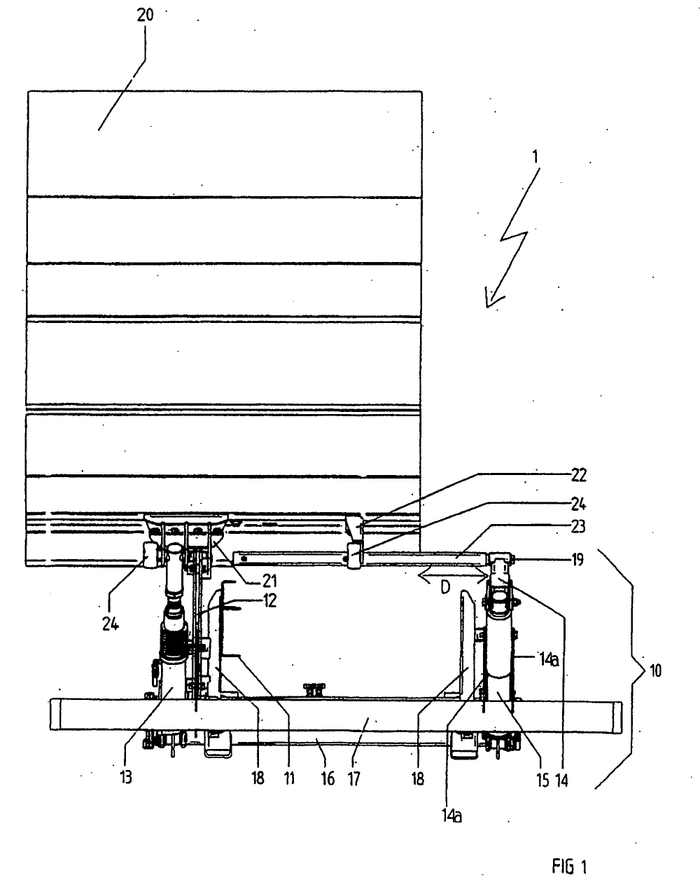

FIG. 1 shows the rear view of the inventive partial lifting loading platform of the two-third version;

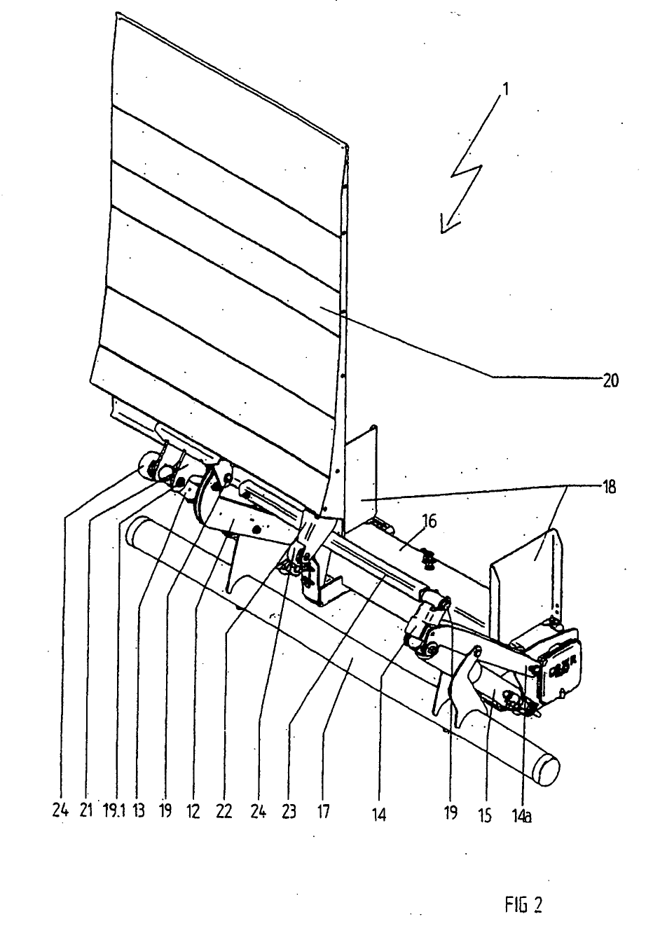

FIG. 2 shows a perspective view of the partial lifting loading platform of FIG. 1;

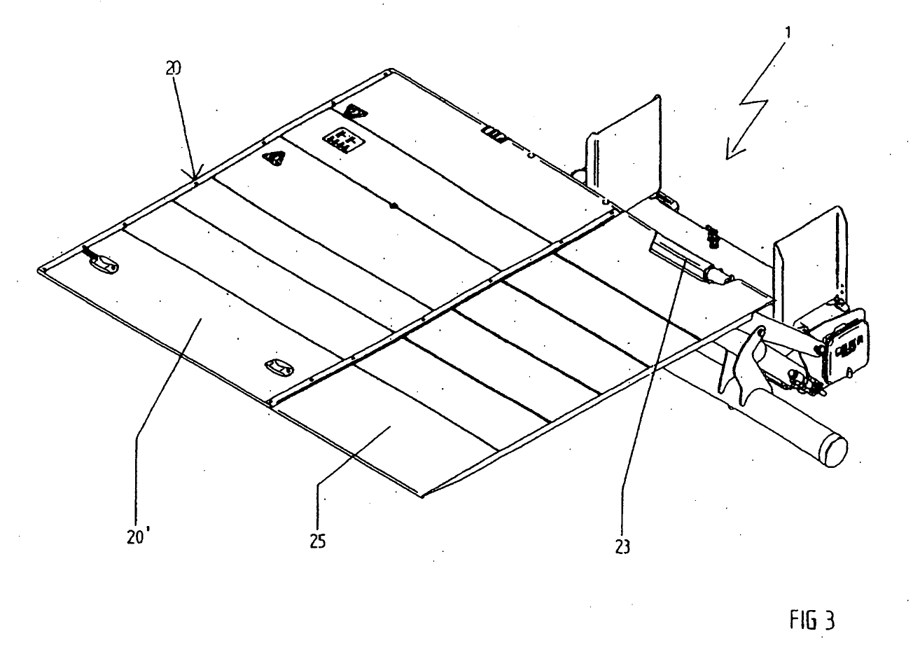

FIG. 3 shows the lifting loading platform of FIG. 1 with unfolded platform, ready for operation, at the loading platform level of the vehicle (not shown); and

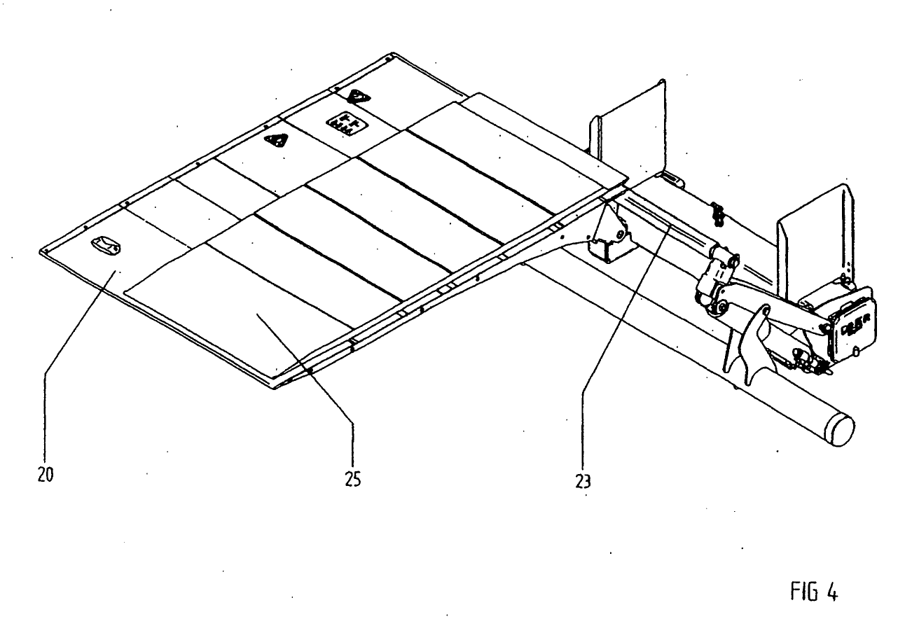

FIG. 4 shows the lifting loading platform of FIG. 3 with a platform folding part which is unfolded by 180° onto the solid platform part.

The two-cylinder lifting loading platform 1 shown in FIG. 1 comprises a substantially parallelogram-shaped lifting gear 10 for a platform 20. The lifting gear 10 has two horizontally spaced-apart support arms 12, 14 for supporting the platform 20, a parallel cylinder 13 associated with the first support arm 12 for pivoting the platform 20 about the axis of rotation 19 from its vertical position of travel into its horizontal operating position and vice versa, a lifting cylinder 15 disposed below the other, second support arm (lifting arm) 14 for lifting and lowering the platform 20 in its horizontal operating position, and a torsion and bending profile 17 for coupling the motion of the lifting cylinder 15 and the first support arm 12. This torsion and bending profile 17 simultaneously forms an underride protection. The lifting cylinder 15 engages two lifting cylinder levers 14a (FIG. 1) and forms therewith a triangle of forces, wherein the lifting cylinder levers 14a are motionally elastically coupled to the second support arm 14 in the lifting direction via a spring means (not shown). The lifting cylinder levers 14a are disposed to be rotatable about the axis of rotation of the support arms 12, 14. The platform 20 is supported by both support arms 12, 14 and the parallel cylinder 13. The two support arms 12, 14 form one parallelogram strut and the parallel cylinder 13 forms the other parallelogram strut of the lifting gear 10.

With respect to the exact function, reference is made to EP 03 017 414.8 of the applicant which is hereby incorporated by reference.

The lifting gear 10 has a support tube 16 on which the support arms 12, 14 and the cylinders 13, 15 are disposed in a rotatable fashion, and which is mounted to the vehicle chassis frame 11 via suspension plates 18. The platform 20 has a connecting head 21 which is rotatably connected to the first support arm 12 via the center of rotation 19 (better shown in FIG. 2). The platform 20 is a two-third version which is spaced apart from the second support arm 14 in a transverse direction. The platform 20 is also disposed on the second support arm 14 to be rotatable about the pivot axis 19 using a transverse support 23 bridging this transverse separation D. The parallel cylinder 13 is disposed in the center of rotation 19.1 (FIG. 2). The parallel cylinder 13 pivots the platform 20 about the axis of rotation 19 through slightly more than 90°. The transverse support 23 is screwed to the tongue-shaped end edge of the platform 20. The other end of the transverse support 23 is bolt-shaped and disposed in the eye of the second support arm 14. In this version, the platform width may have any dimension within the scope of vehicle construction width.

When the platform 20 is lowered to the ground, it is supported on two bottom rollers 24. The bottom roller 24 on the left-hand side in FIG. 1 is disposed in the connecting head 21, which corresponds to the standard version of the lifting loading platform, in the center of rotation 19.1 of the parallel cylinder 13. The right-hand bottom roller 24 is connected to the platform 20 via a support bracket 22 and is also disposed about the axis of rotation 19.1.

FIG. 2 shows a perspective view of the lifting loading platform 1 of FIG. 1. The vehicle chassis frame 11 is not shown for reasons of clarity, such that the other components are better visible.

FIG. 3 shows the two-third version of FIG. 1 of the lifting loading platform 1 with operationally ready (i.e. horizontal) platform 20 at the loading platform level of the vehicle (not shown). The platform 20 is formed by a solid platform part 20′ and a platform folding part 25. The folding part 25 is connected to the solid part 20′ through a double joint with abutment (not shown in detail). In the illustrated unfolded state, the folded part 25 is supported on the connecting carrier 23. The folding part 25 itself is formed as a welded profile construction of a thickness of 30 or 40 mm. The tongue-shaped design in the area of the center of rotation 19 corresponds to the solid part 20′. The folding part 25 of FIG. 4 is unfolded through 1800 onto the solid part 20′. To prevent the folding part 25 from striking against the construction doors in the travelling position (900 perpendicular direction), it is secured with a lock (not shown).

The invention is not limited to the above-described two-cylinder lifting loading platform but may also be applied to four-cylinder lifting loading platforms, wherein one lifting and one parallel cylinder are associated with each of the two support arms.

1-8. (canceled)

9. A lifting loading platform for vehicles, the platform comprising:
a platform member;
mean defining a pivot axis of said platform member;
a first support arm cooperating with said platform member;
a second support arm disposed at a transverse separation from said platform member;
a platform folding part disposed on a side of said platform member facing said second support arm, wherein said platform folding part is structured for pivoting through 180°;
a transverse support disposed between said second support arm and said platform member to bridge said transverse separation;
at least one rotation cylinder cooperating with said platform member to rotate said platform member or said platform folding part about said pivot axis between a vertical travelling position and a horizontal operating position; and
at least one lifting cylinder cooperating with said platform member to lift and lower said platform member in said operating position.

10. The lifting loading platform of claim 9, wherein said platform member has a connecting head on which said first support arm and said parallel cylinder engage.

11. The lifting loading platform of claim 9, wherein said transverse support is screwed to said platform member.

12. The lifting loading platform of claim 9, wherein said transverse support has a bolt-shaped end which is disposed on said second support arm.

13. (canceled)

14. The lifting loading platform of claim 13, wherein said platform folding part is supported on said transverse support.

15. The lifting loading platform of claim 9, wherein said platform member has two spaced-apart bottom rollers.

16. The lifting loading platform of claim 9, wherein said lifting cylinder engages at least one lifting cylinder lever which is rotatably disposed about said pivot axis and forms therewith a triangle of forces, wherein said second support arm is elastically motionally coupled to said lifting cylinder lever in a lifting direction and said first support arm is connected to said lifting cylinder lever using a torsion and bending profile.
